(19) United States
(12) Patent Application Publication
(10) Pub. No.: US 2025/0054160 A1
(43) Pub. Date: Feb. 13, 2025

(54) AUTOMATED ANALYSIS OF FOAM SAMPLES

(71) Applicant: TOTAL ENERGIES ONETECH, Courbevoie (FR)

(72) Inventor: Michael LEVANT, Pau (FR)

(21) Appl. No.: 18/720,464

(22) PCT Filed: Dec. 17, 2021
(86) PCT No.: PCT/IB2021/000913

§ 371 Date: Jun. 14, 2024

(51) Int. Cl. G06T 7/136; G06T 7/00; G06T 11/20; G06T 11/60; G06V 10/62; G06V 10/762

(52) U.S. Cl. CPC G06T 7/136; G06T 7/0004; G06T 11/203; G06T 11/206; G06T 11/60; G06V 10/62; G06V 10/763; G06T 2207/10016; G06T 2207/20081

(57) ABSTRACT

The disclosure notably relates to a computer-implemented method for analyzing the temporal evolution of a foam sample. The method comprises providing a time-series set of images of a foam sample subject to a shrinking process in a predetermined shrinking direction. The method also comprises generating a spatiotemporal diagram image from the time-series set of images. The spatiotemporal diagram image represents time evolution of a layout of the foam sample in the predetermined shrinking direction. The method also comprises segmenting the spatiotemporal diagram image into a set of segments. The method also comprises creating one or more curves that represent boundaries of the segments. This forms an improved solution for analyzing a foam sample.

### TECHNICAL FIELD

The present disclosure relates to the field of computer programs and systems, and more specifically to a method, a program, a storage medium and a system for analyzing the temporal evolution of a foam sample.

### BACKGROUND

Foams are ubiquitous in various fields. Their physical and chemical properties stir lots of interest in a variety of applications, ranging from enhanced oil recovery, degassing of crude oil, to solvents for CO2 capture, aeration of lubricants in car engines and many more. Depending on application the stability of the foam may be desired (like in exchangers) or not (like in service stations) or inevitable (like in separators) but preferable to know as it impacts the system design. The physical and chemical properties, in particular the stability of a foam, have a great impact on the applications, and assessment of these properties is crucial.

Image analysis is one way to assess properties of foams. However, image analysis is usually a manual approach involving manual image acquisition. Said approach is tedious, time consuming and prone to errors and irreproducible. In addition, the extracted information is very limited due to the manual nature of the acquisition, and so is the time resolution.

The manual approach can be further enhanced by acquiring the images at different times of the foam lifetime, and further using commercial software tools for image analysis such as ImageJ. However, such manual approach relies heavily on user intervention, and only provides limited information. The time resolution of the image acquisition is still limited to the limited number of images that can be acquired manually, and the time resolution of the image analysis is also limited to the resolution of the manual analysis.

There exist some automated solutions. However, the main challenge in such solutions is the classification of the images to foam and not-foam regions on each image.

Some existing solutions are based on finding the highest derivatives of the intensity/grayscale of an acquired image. Said solutions thus require a high contrast on the boundary between two regions, and low contrast variation within each of the phases. However, foams are characterized by having a low contrast at the top boundary, especially close to the end of life, and thus it is not feasible to apply such existing solutions to foam and non-foam regions.

Another solution available in the market is the Dynamic Foam Analyzer DFA 100 by Kruss package (instrument+software). However, this solution can be applied only to a narrow range of foams, for example cannot be applied to solvents, e.g., present in degassing of crude oils. In addition, such system has further limitations such as requiring large volumes, limitations in temperature, or the frame rate of the acquisition system. All of these limitations may limit the overall length of the experiment, or the number of samples that can be analyzed simultaneously.

Within this context, there is still a need for an improved method for analyzing the temporal evolution of a foam sample.

### SUMMARY

It is therefore provided a computer-implemented method for analyzing the temporal evolution of a foam sample. The method comprises providing a time-series set of images of a foam sample subject to a shrinking process in a predetermined shrinking direction. The method also comprises generating a spatiotemporal diagram image from the time-series set of images. The spatiotemporal diagram image represents time evolution of a layout of the foam sample in the predetermined shrinking direction. The method also comprises segmenting the spatiotemporal diagram image into a set of segments. The method also comprises creating one or more curves that represent boundaries of the segments.

The method may comprise one or more of the following:
the generating of the spatiotemporal diagram image may comprise:
   determining, from each respective image of the time-series set of images, a pixel stack representing the layout of the foam sample in the predetermined shrinking direction; and
   juxtaposing laterally the pixel stacks:
the determining of each respective pixel stack may comprise, for each respective pixel of the pixel stack, averaging pixels of the respective image in a direction perpendicular to the predetermined shrinking direction;
the segmenting may be based on one or more graphical characteristics of the spatiotemporal diagram image including:
   one or more pixel characteristics, such as intensity and/or grayscale level,
   one or more local neighborhood characteristics, such as texture, entropy and/or standard deviation,
   one or more pattern presence,
   one or more connectivity criteria, and/or
   one or more similarity criteria:
the segmenting may be based, for at least one respective graphical characteristic, on one or more thresholds of the respective graphical characteristic;
the method may comprise determining at least one respective threshold of a respective pixel characteristic by applying at least one of K-means clustering and Otsu's method;
the segmenting may comprise applying a predetermined learning model, for example to determine at least one respective threshold of a respective pixel characteristic;
the determining of the at least one respective threshold may comprise applying the learning model to the diagram;
the predetermined learning model may be a logistic regression model;
the providing of the time-series set of images may comprise:
   positioning the foam sample in front of a camera sensor; and
   capturing the time-series set of images with the camera sensor;
the capturing may be performed while lighting the foam sample;
the method may further comprise:
   setting a region of interest on at least one of image; and
   extracting, from each image, a respective sub-image corresponding to the region of interest:
the spatiotemporal diagram image being generated based on the sub-images;
the foam sample may be contained in a sampling tube having a bottom and an opening, the sampling tube being positioned vertically with the bottom downwards and the top upwards, the foam sample shrinking downwardly due to gravity;
the method may further comprise displaying, on a graphical-user interface, the created one or more curves, optionally superposed on the generated spatiotemporal diagram image;
the method may further comprise computing a half-life and/or a drainage velocity of the foam sample from the one or more curves, and optionally displaying a graphical representation of the half-life and/or the drainage velocity;
computing the half-life and/or drainage velocity from the one or more curves may comprise determining a weighted sum of the one or more curves; and/or
the foam sample may be one of:
   a non-aqueous foam, such as:
      a depressurization-induced foam optionally in a separator, the foam for example including hydrocarbons, such as crude oil and separating pockets of dissolved natural gases,
      gas treatment column foam, for example including selexol, and separating pockets of H2S, and/or CO2,
      a vehicle lubricant foam optionally in an electric vehicle gearbox, for example including mineral oil-based lubricant and separating pockets of air, or
      a fuel foam optionally in a service station, or
   an aqueous foam, such as:
      an enhanced oil recovery (EOR) foam, for example separating pockets of CO2, nitrogen, natural gas, and/or air, or
      a gas treatment column foam, for example including amine-based solvents, and separating pockets of CO2 and/or H2S.

It is further provided a computer program comprising instructions for performing the method.

It is further provided computer readable storage medium having recorded thereon the computer program.

It is further provided a system comprising a processor coupled to a memory, the memory having recorded thereon the computer program.

### BRIEF DESCRIPTION OF THE DRAWINGS

Non-limiting examples will now be described in reference to the accompanying drawings, where:

FIG. 1 shows a flowchart of an example of the method;

FIG. 2 shows an example of the system:

FIGS. 3 and 4 show examples of images of foam samples;

FIG. 5 shows an example of a GUI for performing the method:

FIG. 6 shows an example of a pixel stack which may be computed from a mean grayscale profile:

FIGS. 7 and 8 show examples of the spatiotemporal diagram image:

FIG. 9 shows an example of a segmented spatiotemporal diagram image with a user interface for manual adjustment of thresholds for segmentation:

FIG. 10 shows examples of curves representing boundaries of the segments:

FIG. 11 shows examples of computing a half-life from the curves:

FIGS. 12 and 13 show examples of training data for a learning model for determining at least one predetermined threshold for the segmenting; and

FIGS. 14 to 18 show different examples of the segmentation of the spatiotemporal diagram image.

### DETAILED DESCRIPTION

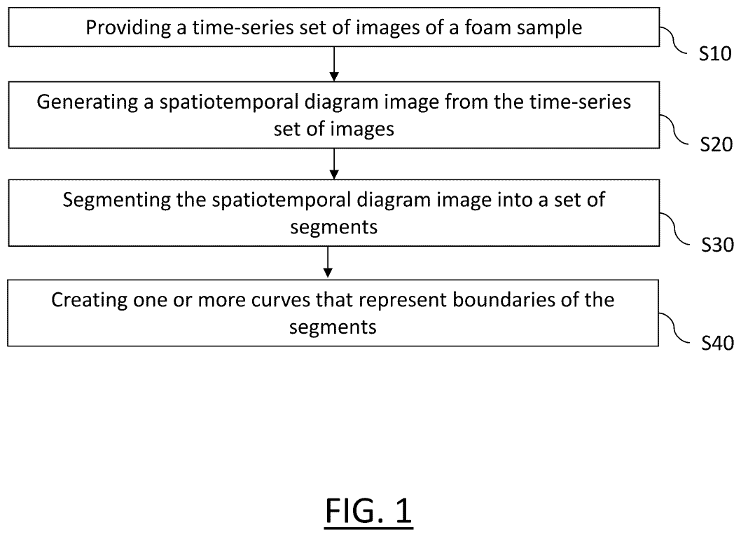

With reference to the flowchart of FIG. 1, it is proposed a computer-implemented method for analyzing the temporal evolution of a foam sample. The method comprises providing S10 a time-series set of images of a foam sample subject to a shrinking process in a predetermined shrinking direction. The method also comprises generating S20 a spatiotemporal diagram image from the time-series set of images. The spatiotemporal diagram image represents time evolution of a layout of the foam sample in the predetermined shrinking direction. The method also comprises segmenting S30 the spatiotemporal diagram image into a set of segments. The method also comprises creating S40 one or more curves. The one or more curves represent boundaries of the segments.

Such a method improves the analysis of the temporal evolution of a foam sample. Indeed, the time-series set of images forms a sequential set of images, wherein each element of the set (also called “snapshot”) captures the dynamic of the foam at a given instant of time, and in particular the current state of its shrinkage. The method then gathers the time-series set of images in a single image, that is, the spatiotemporal diagram image. The spatiotemporal diagram image captures the whole process, such that image processing thereof allows to perform the temporal evolution analysis. In particular, the segmenting of the spatiotemporal diagram image graphically identifies regions where the shrinkage dynamics of the foam presents consistency. As a result, the boundaries of the segments directly inform on shrinkage characteristics of the foam. Thus, each constructed curve yields an objective assessment of the evolution of the foam subject to the shrinkage process. Consequently, the method allows an objective assessment of how structural properties of the foam change over time, and this could not be assessed from a single snapshot. Moreover, the method provides a fast and precise way for assessing the structural properties of the foam over large datasets. Indeed, the method handles a time-series set of images comprising multiple (e.g., at least 100, 1000 yet 10000 or more) images in a single process. Experiments show that the processing of the full dataset may take only a few minutes, whereas a manual processing of the images normally takes many hours, and may be prone to manual sampling errors.

The method is computer-implemented. This means that steps (or substantially all the steps) of the method are executed by at least one computer, or any system alike. Thus, steps of the method are performed by the computer, possibly fully automatically, or, semi-automatically. In examples, the triggering of at least some of the steps of the method may be performed through user-computer interaction. The level of user-computer interaction required may depend on the level of automatism foreseen and put in balance with the need to implement user's wishes. In examples, this level may be user-defined and/or pre-defined. In an example, the providing S10 may be performed through user-interaction, e.g. via a user manipulating the foam sample and a camera having a sensor to capture the time-series set of images and/or (e.g. then) retrieving the time-series set of images (e.g, from local or remote memory), and the generating S20, the segmenting S30, and the creating S40 may be performed fully automatically (e.g, after user-launching a software functionality therefore).

A typical example of computer-implementation of the method is to perform the method with a system adapted for this purpose. The system may comprise a processor coupled to a memory and a graphical user interface (GUI), the memory having recorded thereon a computer program comprising instructions for performing the method. The memory may also store the provided time-series set of images. The memory is any hardware adapted for such storage, possibly comprising several physical distinct parts (e.g, one for the program, and possibly one for the provided time-series set of images).

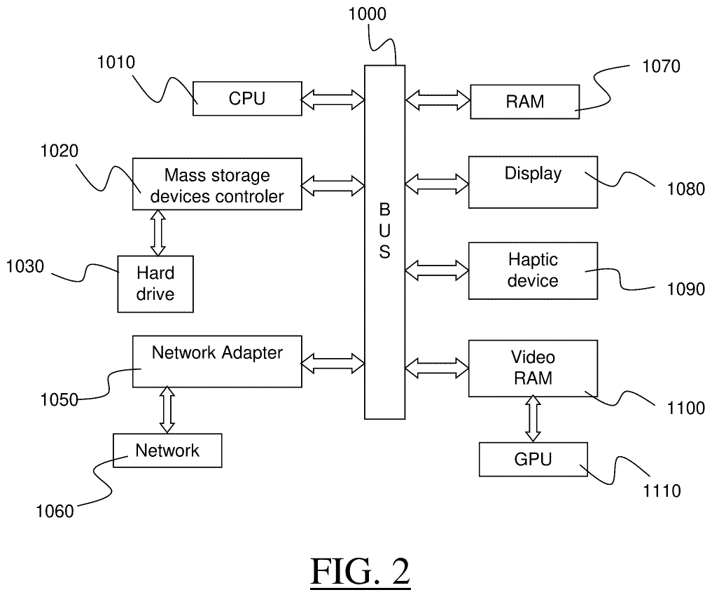

FIG. 2 shows an example of the system, wherein the system is a client computer system, e.g, a workstation of a user.

The client computer of the example comprises a central processing unit (CPU) 1010 connected to an internal communication BUS 1000, a random access memory (RAM) 1070 also connected to the BUS. The client computer is further provided with a graphical processing unit (GPU) 1110 which is associated with a video random access memory 1100 connected to the BUS. Video RAM 1100 is also known in the art as frame buffer. A mass storage device controller 1020 manages accesses to a mass memory device, such as hard drive 1030. Mass memory devices suitable for tangibly embodying computer program instructions and data include all forms of nonvolatile memory, including by way of example semiconductor memory devices, such as EPROM. EEPROM, and flash memory devices: magnetic disks such as internal hard disks and removable disks: magneto-optical disks. Any of the foregoing may be supplemented by, or incorporated in, specially designed ASICs (application-specific integrated circuits). A network adapter 1050 manages accesses to a network 1060. The client computer may also include a haptic device 1090 such as cursor control device, a keyboard or the like. A cursor control device is used in the client computer to permit the user to selectively position a cursor at any desired location on display 1080. In addition, the cursor control device allows the user to select various commands, and input control signals. The cursor control device includes a number of signal generation devices for input control signals to system. Typically, a cursor control device may be a mouse, the button of the mouse being used to generate the signals. Alternatively or additionally, the client computer system may comprise a sensitive pad, and/or a sensitive screen.

The computer program may comprise instructions executable by a computer, the instructions comprising means for causing the above system to perform the method. The program may be recordable on any data storage medium, including the memory of the system. The program may for example be implemented in digital electronic circuitry, or in computer hardware, firmware, software, or in combinations of them. The program may be implemented as an apparatus, for example a product tangibly embodied in a machine-readable storage device for execution by a programmable processor. Method steps may be performed by a programmable processor executing a program of instructions to perform functions of the method by operating on input data and generating output. The processor may thus be programmable and coupled to receive data and instructions from, and to transmit data and instructions to, a data storage system, at least one input device, and at least one output device. The application program may be implemented in a high-level procedural or object-oriented programming language, or in assembly or machine language if desired. In any case, the language may be a compiled or interpreted language. The program may be a full installation program or an update program. Application of the program on the system results in any case in instructions for performing the method. The computer program may alternatively be stored and executed on a server of a cloud computing environment, the server being in communication across a network with one or more clients. In such a case a processing unit executes the instructions comprised by the program, thereby causing the method to be performed on the cloud computing environment.

A foam is a mass or accumulation of gas pockets each trapped within a thin liquid film, the thin liquid films thereby separating the gas pockets. A foam may be formed on the surface of a liquid, but possibly sampled and separated from such liquid. As opposed to liquids having gas bubbles, a foam contains a larger ratio of gas volume over liquid volume (i.e. liquid inside the foam, that is, not counting any liquid present under the foam). The foam sample provided at S20 may for example present a value of such ratio higher than 1.5 or 2, or even 10 or 100 (e.g. corresponding respectively to wet and dry foams).

The foam sample may be, for example, a non-aqueous foam. The non-aqueous foam may be a depressurization-induced foam. Such a depressurization-induced foam may for example appear in (and be sampled from) a separator. For example, the separator may include hydrocarbons, such as crude oil and/or dissolved natural gases. The non-aqueous foam may alternatively be a gas treatment column foam. The film of the foam may include, for example, selexol, separating pockets of H2S, and/or CO2. The non-aqueous foam may alternatively be a lubricant foam, for example a foam generated in an electric vehicle gearbox. The film of the foam may, for example, include mineral oil-based lubricant, separating pockets of air. The non-aqueous foam may alternatively be a fuel foam. Optionally, the foam may be a foam in a service station.

The foam sample may alternatively be an aqueous foam. For example, the aqueous foam may be an enhanced oil recovery (EOR) foam. The EOR foam may include, for example, pockets of carbone dioxide (CO2), nitrogen, natural gas, and/or air. The aqueous foam may alternatively be a gas treatment column foam, for example including films of amine-based solvents, separating pockets of CO2 and/or H2S.

Depending on the application, stability of the foam may be desired (like in exchangers, or in EOR) or not (like in service stations) or inevitable (like in separators) but preferable to know as it impacts the system design.

By “time-series set”, it is meant a sequential collection of images ordered by time (i.e. chronologically). The time-series set of images may comprise a timestamp and/or dating information (e.g. including day and/or time) for at least part (e.g, all) images, or alternatively no such precise information. In the latter case, the data structure forming the time-series set of images may be arranged so as to retrieve the sequence between the image, or the time-series set of images may comprise an ordering index for each image. In any case, the images in the time-series may be separated by a uniform amount of time or, alternatively, by a non-uniform amount of time. The generating S20 of the spatiotemporal diagram image may be based on the ordering between the images of the time-series. Optionally, the generating S20 of the spatiotemporal diagram image may further be based on the exact time of at least part (e.g, all) the images, when the information is available or retrievable, for example when the images are available from a video stream. However, it has been found that the method still produces exploitable results even when biases are introduced by not being able to exactly date the images.

The providing S10 of the time-series set of images may comprise positioning the foam sample in front of (i.e. in the capturing field of) a camera sensor, and capturing the time-series set of images with the camera sensor. The capturing may be performed fully automatically, for example after being user-launched and/or until being user-stopped. Alternatively, the providing S10 may comprise retrieving from (e.g. local or remote) memory a time-series set of images having been obtained in that manner. The images of the time-series set and/or fed to the generating S20 may be the raw images captured by the camera, or alternatively processed beforehand (for example all transformed into grayscale images).

The time-series set of images may comprise any type of images able to represent evolution of the foam shrinkage over time, the providing of the time-series set of images may comprise positioning the foam sample in front of a sensor, including images capture in the visible light spectrum and/or images captured in the non-visible light spectrum, such as including grayscale images, color images (e.g. RGB images). X-ray images and/or infra-red images. The camera may be a video camera and the images of the time-series set comprise (e.g. RGB or grayscale) frames of a video stream acquired from the video camera. In this case, the time-series set may additionally comprise timestamps that may indicate the date and hour of acquisition of each image.

The foam sample is subject to a shrinking process in a predetermined shrinking direction. By “shrinking process” (or “collapsing” process) it is meant any process by which the foam sample contracts (that is, it becomes smaller or more compacted) over time. Thus, the foam sample contracts continuously and monotonously over time in the predetermined shrinking direction. The origin of the shrinking is drainage of the liquid films, and eventual rupture of the liquid films. The foam sample may shrink downwardly due to gravity. Thus, the predetermined shrinking direction may be the direction of gravity (i.e., the vertical direction in a terrestrial reference frame). The time-series set of images graphically represent this shrinking process.

The foam sample may be contained in any container (e.g. vessel or receptacle), such as a (e.g. longitudinal) sampling tube. The sampling tube may have a bottom and an opening. The bottom may thus contain the liquid part of the foam sample, while the opening may allow the contact of the foam with the environment. The sampling tube may be positioned vertically with the bottom downwards and the top upwards. The foam sample may shrink downwardly due to gravity, and the predetermined shrinking direction is thus the direction from the opening to the bottom downwards. The container may be adapted to the type of camera sensor used to capture the images. For example, in case a visible light sensor is involved, the container may be transparent, for example a transparent tube.

The capturing of the images may be performed while lighting (i.e. illuminating) the foam sample, e.g, with a light source (of any type). For example, in each image, the foam sample may be either backlit or front-lit, optionally either backlit in all images or front lit in all images. The foam sample may be positioned between the camera sensor and a light source, or the light source may be in the same side as the camera sensor such as that the foam sample stands in front of both. The position of the light source allows to account for backlit foam of front-lit foam, so that the foam sample can be between the light source and the sensor or in front of both, such that the camera sensor captures reflected light.

As part of a pre-processing to form and provide S10 the time-series set of images, or as a post-processing of the time-series set of images provided at S10 to perform the generating S20, the method may comprise setting a region of interest on at least one given captured image, such as the first captured image. The given image may or may not be included in the time-series set of image (the given image may for example be the first image of the time-series). The method may then comprise extracting, from each captured image, a respective sub-image (i.e. portion of the initial image) corresponding to the region of interest. The spatiotemporal diagram image may then be generated at S20 based on the sub-images (i.e. discarding non-retained portions of the captures images, that is, portions outside the region of interest). Such restriction to a region of interest allows to discard zones of the images providing no information with respect to shrinkage and thereby to improve accuracy, by focusing the segmenting S30 on a relevant region.

In particular, throughout the capturing of the images by the camera sensor, the foam sample may be at a fixed position relative to the camera sensor (e.g, both the camera sensor and the foam sample container are fixed), such that the region interest captures the same portion of the shrinking foam sample. The restriction to such a region of interest thus allows to normalize the images of the time-series and make them more comparable, such that the spatiotemporal diagram image conveys more accurate information for the segmenting S30 to perform accurately.

A region of interest may be a 2D boundary (e.g., such as a bounding box, for example rectangular) enclosing a portion of the foam sample. The region of interest may enclose a portion containing a full height of the foam sample (i.e, a region from one extremity of the foam to the other extremity of the foam, with respect to the shrinking direction, e.g, from the bottom of the foam to the top of the foam when the shrinking direction is vertical), at least in the at least one given captured image, optionally in all the captured images (thus all the images of the time-series). For example, the foam sample may be located over the surface of a liquid in the images of the time-series, and the region of interest may enclose a portion containing a whole height of the foam sample in contact with the surface of the liquid.

The region of interest may be set manually (e.g., via a graphical user interface) or fully automatically, e.g., via a region of interest algorithm that sets bounding boxes on the foam sample. For example, the method may set (manually or fully automatically) a dimension for a bounding box, and place it in a position enclosing the foam sample. In another example, only the dimensions of the bounding box may be set manually, whereas the positioning of the bounding box may be set automatically.

The spatiotemporal diagram image is an image representing the time evolution of a layout of the foam sample in the predetermined shrinking direction. The layout represents a spatial arrangement of the foam sample along the predetermined shrinking direction. The layout may be defined with respect to one or more space occupation properties of the foam including, for example, local density of the foam (the number of gas pockets per unit volume) and/or foam presence (corresponding to the length—e.g. height—of the foam sample) along the predetermined shrinking (e.g. vertical) direction, and/or liquid volume fraction. As the foam sample is subject to the shrinking process and the foam thereby occupies less and less space and/or becomes less dense, the layout changes continuously and monotonically over the images of the time-series set. As a result, the spatiotemporal diagram image represents the continuous and monotonical change of the layout of foam sample over time.

The spatiotemporal diagram image may be a 2D image, representing time on one axis (e.g, abscissa axis) and the predetermined shrinking (e.g. vertical) direction on the other axis (e.g, ordinate axis), wherein each pixel represents one or more space occupation property values of the foam, for example local density of the foam, and/or the liquid volume fraction. The spatiotemporal diagram image may for example be a grayscale image, where the level of grey of each pixel represents local foam density (e.g, from a grayscale value of ( ) representing a maximal density of foam and its liquid volume fraction, to a grayscale value of 1 representing absence of any foam).

For example, each pixel (j,y) of the spatiotemporal diagram image, where j represents the abscissa and y represents the ordinate, may represent the value of the one or more space occupation properties, for example the value of foam density, at coordinate y (e.g. height y) along the predetermined shrinking (e.g. vertical) direction as apparent in the image of the time-series set captured at the time corresponding to j (e.g, the j-th image in case of a uniform time-series). The generating S20 may comprise computing said value of pixel (j,y) based on a single pixel value in image j at a same coordinate y, or on an average of pixel values in image j all at the same coordinate y. The images of the time-series set may be of the same nature as the spatiotemporal diagram image, such that the computation may consist in retrieving a pixel value in image j or averaging pixel values in image j. For example, both the images of the time-series set may be grayscale images, such that retrieving or averaging pixel values thereof directly yields grayscale values. Alternatively, the images of the time-series set may be of a different nature as the spatiotemporal diagram image, such that the computation may comprise a pre-processing before or a post-processing after such retrieving/averaging. Thanks to the averaging, the spatiotemporal diagram image consists of averaged profiles and accurately informs on foam state at a certain time. The averaging eliminates outliers that may yield incorrect boundaries of the segments of the spatiotemporal diagram image. Thus, the curves created at S40 are smoother and provide more accurate information about the shrinking process.

In a particularly efficient example, the time-series set provided at S10 may consist of J (e.g. grayscale) images having been all obtained from or all being subject to the earlier-mentioned region of interest extraction. The generating S20 may thus be fed with a number J of images all presenting the same dimensions X*Y. In such a case, the value of each pixel (y,j) of the spatiotemporal diagram image, with j from 1 to J and y from 1 to Y, may for example be equal to the average of the value of all pixels (x,y) of image j, with x from 1 to X, that is, the average value of row y of image j, with or without a pre-processing or post-processing (e.g. without, in case the spatiotemporal diagram image is—also—a grayscale image).

An optional manner to possibly achieve such results is now discussed.

The generating S20 may comprise determining, from each respective image of the time-series set of images, a pixel stack. The pixel stack represents the layout of the foam sample in the predetermined shrinking direction, for each image of the time-series set of images. In other words, the pixel stack is a linear and continuous arrangement of pixels. The pixel stack may be straight, for example in the direction of the shrinking direction (e.g. vertical in particular when the predetermined direction is the gravity direction). The generation S20 may further comprise juxtaposing laterally the pixel stacks.

For example, the method may juxtapose the pixel stacks by first setting (by convention) the pixel stack of the first image of the time-series as a (e.g., vertical with respect to a standard x-axis) column of pixels in the first left-wise column of pixels of the spatiotemporal diagram image, e.g., with respect to the standard x-axis of the diagram. Then, the method may proceed the juxtaposing by stacking laterally (towards the rightmost direction of the x-axis of the diagram) the pixel stacks of the images of the time-series set in the order set by the associated timestamp. In this manner, the spatiotemporal diagram image represents the time evolution of the layout in the chronological order in which the images are found in the time series. Thus, the creation of the one or more curves follows the continuous and monotonical change (e.g., in volume and/or density of the mass of gas pockets of the foam sample) of the stack of pixels corresponding to the shrinking process to which the foam sample is subject to.

The determination of each pixel stack (of each respective image of the time series) may comprise, averaging pixels of the respective image in a direction perpendicular to the predetermined shrinking direction. That is, the method may sum values of a group of pixels in the direction perpendicular to the shrinking direction and divide the sum by the number of pixels in the group. For example, if the predetermined shrinking direction is a standard y-axis of each image (comprising say, X pixels) the method may average one or more pixels in the standard x-axis (comprising say, Y, pixels). Thus, the method may create a pixel stack of length Y, where each entry y, where 0<y≤Y, is the average of k pixels (where 0<k≤X) along the x-axis at the position y of the vertical axis. The method may also select one or more vertical columns of pixels for each image. The method may determine a pixel stack as another column, wherein each entry is the average of the pixels of the corresponding entries of the vertical columns of pixels. For example, the method may compute a region of interest from the image. The method may thus determine the pixel stack from that region of interest.

The segmentation S30 consists in a partitioning of the spatiotemporal diagram image into different and disjoint sets (i.e, segments) of pixels, e.g, that cover at least a part of (e.g., all of) the spatiotemporal diagram image, each segment presenting a graphical consistency. The method may determine each of the segments based on one or more graphical characteristics of the spatiotemporal diagram image, for example based on a single graphical characteristic so as to perform fast and robustly. Thus, each segment represents a zone of pixels presenting a certain graphical consistency with respect to the one or more graphical characteristics. It has been identified empirically that the consistency of the graphical characteristic, in the spatiotemporal diagram image, is associated to the liquid volume fraction and/or density of the foam sample along the time-series set of images. The segments of the spatiotemporal diagram image thus form blocks representing a respective aspect of the shrinking process.

The segmenting may be based, for at least one respective graphical characteristic, on one or more (e.g. exactly two) thresholds of the respective graphical characteristic, for example the single characteristic, or each graphical characteristic for which such one or more thresholds may be defined. In other words, a respective pixel or subset of pixels is assigned to a respective segment based on how the value of the respective graphical characteristic for that respective pixel or subset of pixels compares to the one or more thresholds. The one or more thresholds (e.g. exactly two) define two or more (e.g. exactly three) ranges of values. Pixels or subset of pixels may then be required to present a value for the at least one respective graphical characteristic falling within a same range in order to be assigned to a same segment.

That is, the method may determine the segments based on one or more thresholds on properties each belonging to one or more pixel regions of the spatiotemporal diagram image, each respective property being related to the temporal evolution of the foam sample along the time-series set of images. Thus, the method may partition the spatiotemporal diagram image into segments which are representative of the time evolution. For example, the method may determine (and perform the segmentation based on) the thresholds so that the curves created from the segments extract the behaviour of the shrinking of the foam sample along the time-series set of images.

The one or more graphical characteristics may include one or more pixel characteristics. By “pixel characteristic” it is meant a property belonging to each individual pixel of the spatiotemporal diagram image. For example, the pixel characteristic may include the intensity of each pixel. Thus, the segmenting may form segments comprising groups of pixels according to one or more intensity thresholds. Additionally or alternatively, the pixel characteristic may include a grayscale level of each pixel. Thus, the segmenting may form segments comprising groups of pixels according to one or more grayscale thresholds.

The one or more graphical characteristics may also include one or more local neighborhood characteristics. By “neighborhood characteristic” it is meant a property of each pixel within a group, which is also dependent of the neighboring pixels. In examples, the one or more local characteristics may comprise texture.

In examples, the one or more local characteristics may comprise the entropy of groups of pixels. The entropy is a statistical measure of randomness that encodes patterns of texture of the spatiotemporal diagram image with respect to the randomness information encoded in the subsets of pixels. Indeed, a low entropy (e.g., entropy zero) means that there is low randomness of the subsets of pixels and thus less detail. The value of the entropy increases as the randomness among neighboring pixels within a respective subset increases. The method may assign a respective subset of pixels to a respective segment based on how the value of the entropy for that respective subset of pixels compares to one or more thresholds. The one or more thresholds define two or more ranges of entropy. A given subset of pixels may then be required to present an entropy value falling within a same range in order to be assigned to a same segment.

Additionally or alternatively, the one or more local characteristics may comprise standard deviation. The standard deviation is a probabilistic measure of dispersion of pixel characteristics (e.g., grayscale or intensity) among a neighborhood of pixels. Indeed, a low standard deviation (e.g., standard deviation zero) means that the pixel characteristic values of pixels a given neighborhood are closer to the mean (in a probabilistic sense), whereas a high standard deviation means that the pixel characteristic values are far (i.e., scattered) from the mean. The method may assign a respective subset of pixels to a respective segment based on how the value of the standard deviation for that respective subset of pixels compares to one or more thresholds. The one or more thresholds define two or more ranges of standard deviation. A given subset of pixels may then be required to present an standard deviation value falling within a same range in order to be assigned to a same segment. Additionally or alternatively, the one or more graphical characteristics may also include one or more pattern presence. The segmentation may thus create segments based on detecting the presence of one or more patterns.

For example, low grayscale (e.g. dark) and low texture may correspond to wet foam: intermediate grayscale and high texture may correspond to dry foam, high grayscale (bright) and low texture may correspond to no foam.

Additionally or alternatively, the one or more graphical characteristics may include one or more connectivity criteria. The segmentation may thus create segments based on linking paths of pixels satisfying a respective connectivity degree of pixels sharing a similar characteristic. The respective connectivity degree may be calculated based on a path formed by pixels. In other words, for a certain value m, two pixels may be connected by a path of m pixels if there is a path of m pixels sharing a similar characteristic with respect to each other and with respect to the two pixels.

Additionally or alternatively, the one or more graphical characteristics may include one or more similarity criteria. The segmentation thus creates segments based on one or more pixels within a neighborhood satisfying a comparison with respect to a respective similarity criterion, via a respective measure of similarity. The respective measure of similarity may be a real valued function applied to pixels of the neighborhood. Said similarity measure may increase its value as the similarity increases. The method may assign a respective subset of pixels to a respective segment based on how the value of the similarity value for that respective subset of pixels compares to one or more thresholds. The method may use graph cuts to segment the image according to the one or more similarity criteria.

These examples of the segmentation performed in step S30 result in that the method obtains accurate information of the time evolution of the foam sample, along the time series set of images. Indeed, the segmentation is performed over the spatiotemporal diagram image. The spatiotemporal diagram image represents the time evolution of the layout of the foam sample. Thus, the spatiotemporal diagram image contains groups of pixels representing the shrinking process of the foam along the time-series set of images. The time evolution of the spatiotemporal diagram image can be quite complex and hence precludes a direct interpretation. However, the segmenting extracts information based on graphic characteristics, being properties of the pixels of the spatiotemporal diagram image, in particular properties related to the time evolution. Thus, the segmenting obtains well defined regions of pixels that provide an accurate analysis of the time evolution of the foam sample.

In examples, method comprises determining at least one respective threshold of a respective pixel characteristic by applying at least one of K-means clustering and Otsu's method. K-means clustering and Otsu's method are fast and efficient methods for thresholding an image automatically. Thus, the method performs the segmentation quite efficiently. Alternatively, the method may perform manual threshold determination or setting, with respect to the grayscale.

The segmenting S30 may comprise applying a predetermined learning model. The method may determine, with the predetermined learning model at least one respective threshold of a respective pixel characteristic. The method may thus take as input a spatiotemporal diagram image and output at least one respective threshold of a pixel characteristic. The learning model may be pre-trained, or trained based on a dataset. For example, the training may comprise providing a dataset comprising spatiotemporal diagram images, each associated with one or more thresholds of respective pixels characteristics (so-called “ground truth” data), each spatiotemporal diagram image and its associated ground truth data forming a respective so-called “training sample” or “(training) example”. The provided dataset may have been formed at different times, at different locations, with different systems and/or by different persons or entities. The dataset thus provides training examples so that the predetermined learning model learns to predict the thresholds automatically. As known per se from the field of machine learning, the provided dataset impacts the speed of the learning of the learning model and the quality of the training, that is, the accuracy of the trained learning model to estimate the at least one predetermined threshold. The dataset may be formed with a total number of data that depends on the contemplated quality of the training. This number may be higher than 100, 1.000, or yet 10.000 elements.

The determination of the at least one respective threshold may comprise applying the learning model (after it has been trained) to the diagram. In other words, after training the learning model, the learning model outputs at least one predetermined threshold. This forms a particularly efficient procedure, all thanks to the learning model leveraging from the dataset it was trained with to determine the at least one respective threshold.

The predetermined learning model may be a logistic regression model. The logistic regression model may use a logistic function where its values have been adjusted to the values of the graphical characteristic values provided in the dataset. In other words, the training performs a model fitting, by parametrizing the logistic function to the provided data. The logistic regression model is a computationally efficient learning model that may be applied to a variety of spatiotemporal diagram images, thanks to the fitting to the provided data.

The method creates, in step S40, one or more curves. Each curve represents a respective boundary between at least one (e.g. exactly one) first segment and at least one (e.g. exactly one) second segment. In other words, each curve locates a boundary of the segments in the image, and thus delimits segments. The creating S40 may comprise fitting the boundaries of the determined segments with one or more predetermined functions having adjustable parameters, including for example polynomial functions.

The method may further comprise displaying, on a graphical-user interface (GUI), the created one or more curves. The GUI may thus provide a visual representation of the one or more curves to the user, so that the user can perform qualitative assessments of the time evolution of the foam sample. Optionally, the one or more curves may be superposed on the generated spatiotemporal diagram image. Thus, the user is presented with information of the time evolution of the foam sample, together with all of the information comprised in the spatiotemporal diagram image. The user may thus perform comparisons between the curves and the spatiotemporal diagram image to perform qualitative assessments of the time evolution of the spatiotemporal diagram image.

The method may further comprise computing (e.g, fully automatically) a half-life of the foam sample from the one or more curves. The half-life is the time required for the volume of the sample foam to reduce to half of its initial value. The half-life is computed from the one or more curves, which extract information of the decay of the layout of the sample foam being subject to the shrinking process. For example, the half-life may be computed from a single curve (that is, a curve selected from the one or more curves), or from a weighted sum of the one or more curves.

Additionally or alternatively, the method may comprise computing (e.g, fully automatically) a drainage velocity of the foam sample from the one or more curves. The drainage velocity may be computed from a derivative of the decay of the one or more curves. For example, the method may compute the derivative from a single curve or from a weighted sum of the one or more curves. The derivative may be computed analytically after fitting the curve with an analytical expression. Alternatively, the derivative may be computed from the discrete definition of the derivative. For example, the curve may be a function h over a domain t. The curve may thus be parametrized by a pairs of values (tᵢ, hᵢ). The method may compute

$$\frac{dh}{dt} = \frac{{h}_{i + 1} - {h}_{i}}{{t}_{i - 1} - {t}_{i}} .$$

Optionally, the method may display a graphical representation of the half-life and/or the drainage velocity. Hence, the user is presented with an improved graphical presentation that allows the user to perform qualitative assessments of the time evolution of the foam sample.

In examples, computing the half-life and/or drainage velocity from the one or more curves comprises determining (e.g, fully automatically) a weighted sum of the one or more curves. That is, the method may obtain another curve consisting of a weighted sum of the one or more curves. The method may compute the half-life and/or drainage velocity from said further curve. This allows a fast analysis of foams present in several domains, showing the long term behavior on a variety of applications and industrial fields, from enhanced oil recovery, degassing of crude oil, to solvents for CO2 capture, aeration of lubricants in car engines an many more. For example, the half lifetime indicates the stability of the foam, while the drainage velocity indicates the humidity content of the foam. Thus, the user is provided with a fast and precise method to assess the physical and/or chemical properties linked to the stability and humidity of the foam in its specific context.

In the case of threshold segmenting as earlier-presented, the segmenting S30 may yield segments which form layers of the spatiotemporal diagram image. In such a case, the curves created at S40 may be piled up and separate these layers. Computing the half-life and/or drainage velocity may in such a case be performed based on a single curve, which may be an intermediate curve for the wet foam or the top curve for the dry foam (i.e, not the bottom curve, which may only represent the bottom boundary of the foam sample). Alternatively, the calculations may be performed on height difference between the intermediate curve and the bottom curve and/or the height difference between the top curve and the bottom curve.

As a result of the analysis, the method may comprise adjusting parameters of the foam (e.g, adjusting composition of the foam or the liquid having yielded the foam), producing a foam sample with the adjusted parameters, and repeating the method to perform a new analysis on a sample of the modified foam. The method may thus be iterated several times, each time to improve a desired behaviour of the foam, for example to increase half-life of the foam (for applications where a stable foam is required) or to reduce half-life of the foam (for applications where non-persistent foam is required).

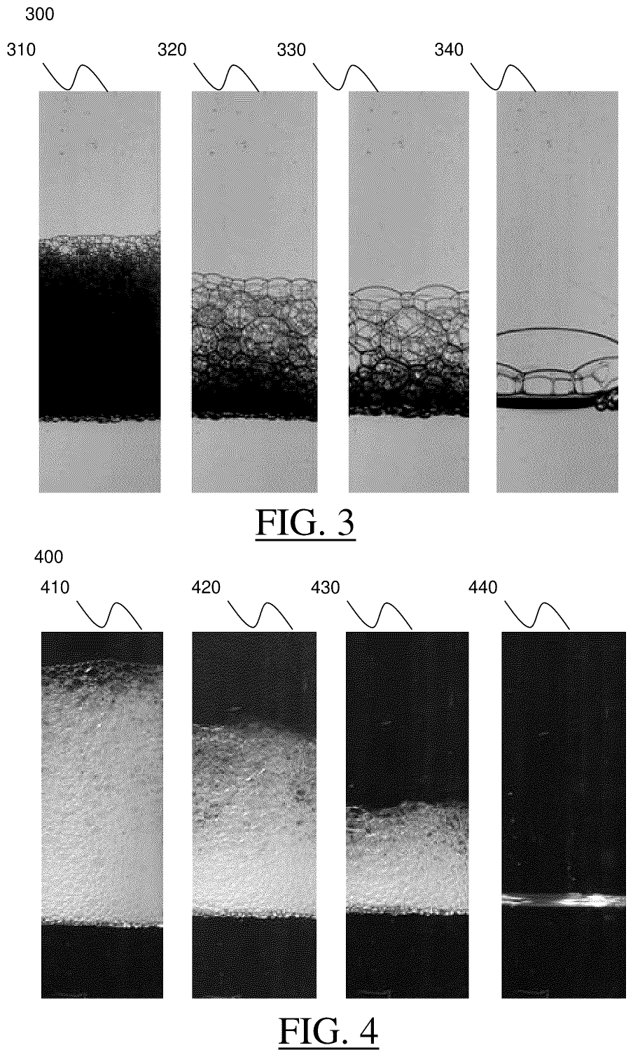

An implementation of the method is now discussed with reference to FIGS. 3 to 18.

FIGS. 3 and 4 illustrate experimental tests of the method that were performed. A visible-light camera was placed in both settings in front of a transparent sampling tube containing a foam sample. In FIG. 3, the experimental protocol set the sampling tube between the visible-light camera and a light source. For the sake of comparison, in FIG. 4, the experimental protocol set the sampling tube in front of both the visible-light camera and the light source. Then, the experiments captured several snapshots of the foam samples as a time series set of images. The snapshots were captured at different times, over the course of many hours of the experiments. The time-series set of images is thus a window of observation of the experiment.

FIG. 3 shows some sample snapshots taken over the course of the experiment 300. The snapshots taken from the experiment 300 are taken with backlighting and captured with a visible light sensor. The snapshot 310 is a snapshot under visible light of the foam sample at the beginning of the experiment. The snapshots 320 to 340 are taken from the same foam sample, however these are taken at subsequent times after the first snapshot 310. The snapshot illustrates the shrinking of the foam sample over time: In particular, the snapshot 340 shows that the foam is quite decayed from its initial layout.

FIG. 4 shows the other experiment 400, where the snapshots are taken with front lighting. The snapshot 410 is a snapshot under visible light of the foam sample at the beginning of the experiment. The snapshots 420 to 440 are taken from the same foam sample, taken at subsequent times after the first snapshot 410. This experiment also illustrates the shrinking process over time of the foam sample.

FIG. 5 is a screenshot illustrating a graphical user interface (GUI). The snapshots may be collected and shown to a user with such a GUI. A user may define parameters for generating the spatiotemporal image via a window 510. The user may specify manually the bounding box 520, and then specify its height in mm (Indicated in box “Height in mm”). The system may convert the height in pixels into metric distance units. The GUI may be configured, for example, to let the user specify the tube where the bounding box is set, e.g., the second tube from left to right of the image). The system may optionally let the user specify the polarity of the image to black-white or the inverse polarity.

To generate the spatiotemporal diagram image, the method may determine, for each image a pixel stack representing a layout of the foam sample. The pixel stack may be computed from a mean grayscale profile of the image. In standard (x,y)-coordinates, the mean grayscale profile of the (vertical) y-coordinate may be expressed mathematically as the following formula: G(y,j)= [symbol] (G(x,y,j) [symbol] ₓ, wherein j is the index of the image in the time-series set of images, [symbol] G(x,y,j) [symbol] ₓ is the average grayscale along all x pixels having the same y-coordinate.

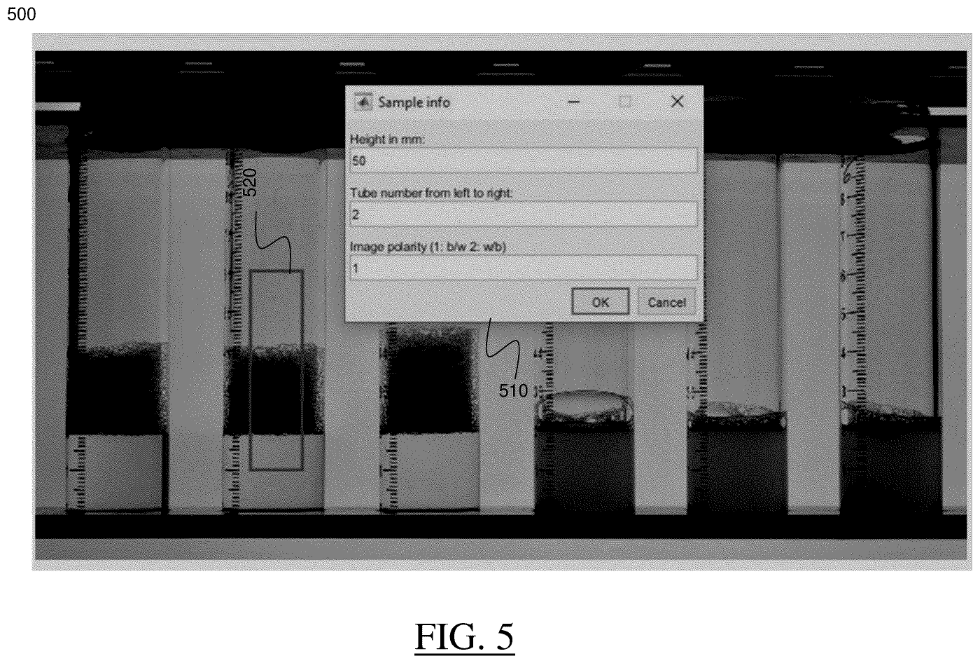

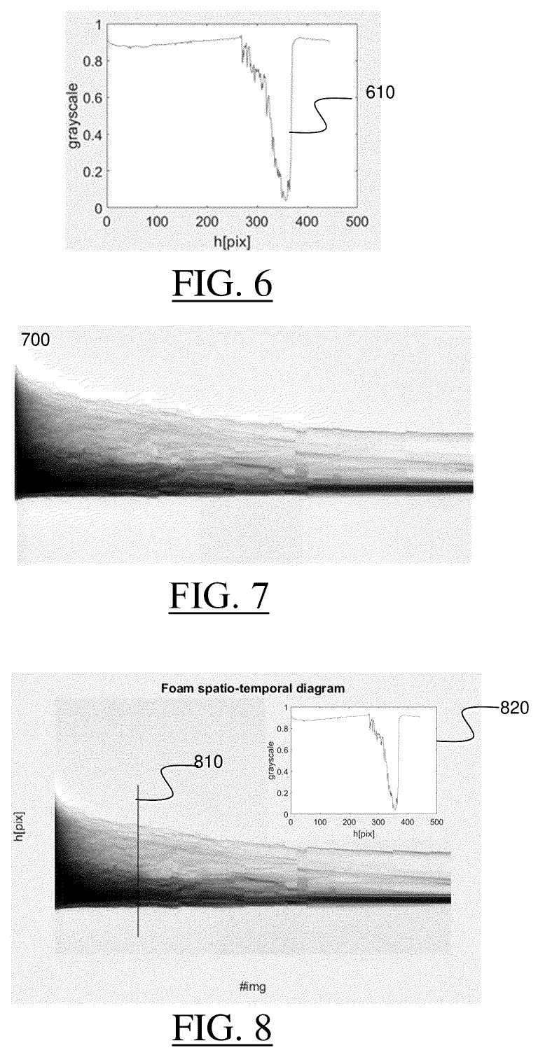

FIG. 6 shows an example of such mean grayscale profile, wherein the grayscale values are normalized to the real interval [0, 1]. In FIG. 6, the grayscale values 610 change close to monotonously inside the foam region.

The same process is performed for all the images indexed in the time series set of images. The spatiotemporal diagram image corresponds to a matrix that stacks together all of the computed mean grayscale profiles. For example, the matrix may be denoted as a matrix A, having entries A_{y,j}=G(y,j).

FIG. 7 shows a single image computed from the entries of the matrix. The spatiotemporal diagram image 700 allows the observation of the temporal evolution of the layout of the foam along the window of observation captured by the snapshots in the time-series set. The user may already do some preliminary qualitative analysis with the spatiotemporal diagram image 700. For example, the user may identify the overall height of the foam, and the internal dynamics of the wet and dry foams, which cannot always be separated visually on a single snapshot. The computation of the spatiotemporal diagram image 700 is quite efficient: in tested implementations (coded in MATLAB) the time required for computing the spatiotemporal diagram image from about 500 images was approximately 60 seconds.

FIG. 8 shows that horizontal position 810 of the spatiotemporal diagram image, indexed by j, corresponds to a mean grayscale profile 820 G(y,j).

The segmentation of the computed spatiotemporal diagram image is now discussed.

The method may determine different regions on the spatiotemporal diagram images to provide a precise quantitative analysis of the foam samples. The system may determine the different regions on the spatiotemporal diagram image. The regions may be associated with the background of the diagram (which may correspond to liquid or air of the environment), wet foam and/or dry foam. The determination may be performed via image segmentation techniques. The image segmentation techniques may be based on similarity analysis, texture, connectivity, grayscale levels, graph cuts, local or global, etc.

The segmentation may allow some degree of user interaction to determine the segments or it may be performed fully automatically.

The segmentation may be performed by any method such as: 1) fixed thresholding (that is, a same threshold may be fixed arbitrarily), 2) user-adjusted thresholding (the user adjusts the threshold), 3) masking, where the thresholds are computed from user-specified regions, 4) another masking, where the masks are determined with respect to a connectivity to user-defined points in the spatiotemporal diagram image. 5) graph cuts based on similarity, 6) texture based segmentation (e.g., using entropy and local standard deviation), 7) intensity/grayscale level thresholding using Otsu's method, K-means clustering. 8) thresholding via a machine learning model, where the classified segmented diagram images are input to a machine learning model to render the segmentation automatic, and the segmentation is based on pretrained model, and/or 9) segmentation based on neural networks. In the tested implementation, it is implemented a particularly ergonomic user-adjusted thresholding, coded in MATLAB.

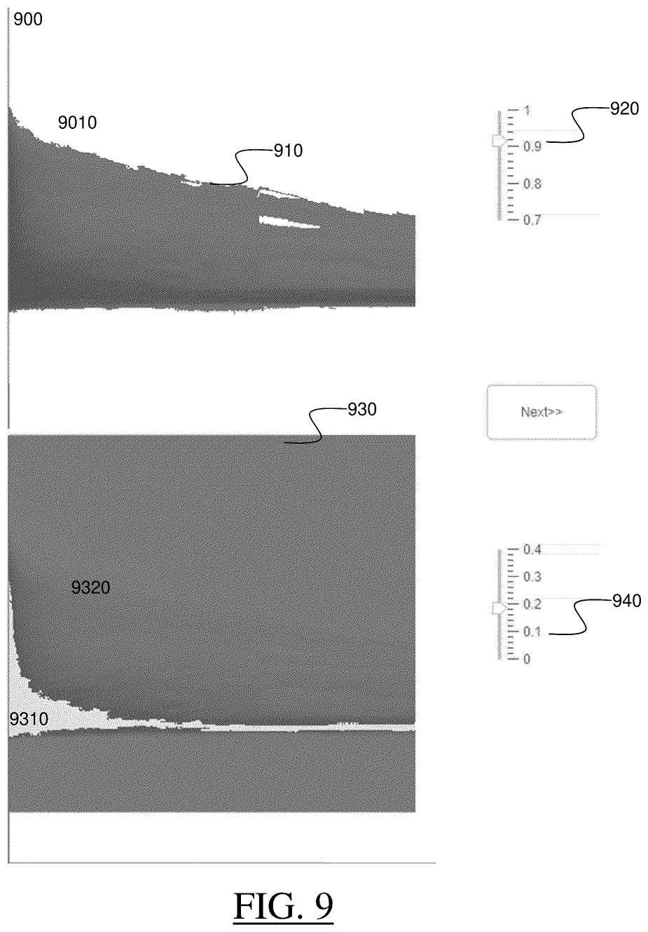

FIG. 9 shows a screenshot of the implementation of such thresholding, adjusted by the user. The user-adjusted thresholding is implemented in the GUI as a pop-up window 900. The pop-up window shows the spatiotemporal diagram image 910 with the background segment (9010) and spatiotemporal diagram image 930 with the wet foam segment (9310). The segment corresponding to dry foam will be defined by pixels that do not belong to the two aforementioned segments. The user may process the intensity of the pixels of the spatiotemporal diagram image 910 with sliders 920 and 940 to adjust the thresholds by which the segments are computed. The resulting segments correspond to the wet foam segment 9310 and the background segment9320. Thus, the graphical user interface enables dynamic adjustment of the high/low thresholds with the slide bars 920 and 940. The user may be optionally presented with the segments superposed in the spatiotemporal diagram image. This implementation is thus a reasonable compromise with respect to a fully automated thresholding.

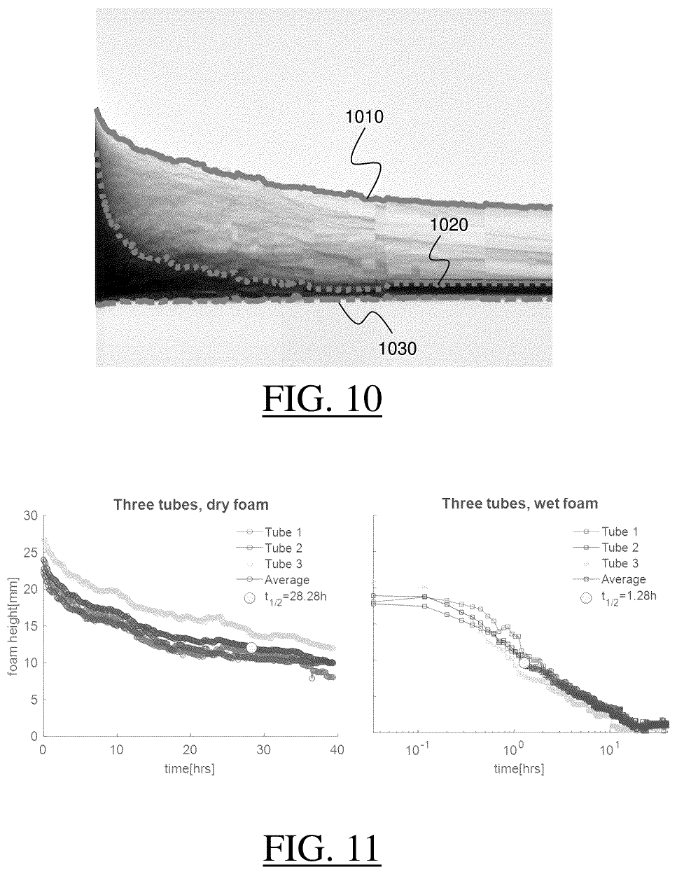

FIG. 10 shows the curves determined from the computed segments, superposed to the corresponding spatiotemporal diagram image. The curves 1010, 1020 and 1030 are obtained by using edge detection techniques. The curves may be used for determining properties such as the half lifetime and drainage velocity.

FIG. 11 shows the computation of lifetimes for an experiment using dry foam and wet foam. The average computed half lifetime for the dry foam is about 22±4 hours. Drainage velocity (not shown in the figures) may be computed by computing the derivative of the height vs time curve. The half lifetime is defined by t:

$$h ( t ) = \frac{1}{2} {H}_{0} ,$$

where H₀ is the difference between the up/bottom interface at t=0. In the example the half lifetime is computed as time t at which the difference

$$\vert h ( t ) - \frac{1}{2} {H}_{0} \vert$$

is minimal. It can also be found from curve fitting and/or interpolation and/or extrapolation.

A manual approach for three tubes containing foam samples requires over 2 hours. In this manual approach, the half lifetime may also be found manually, like in the example above. However, said half lifetime is an approximation with errors due to discrete sampling. In contrast, the method takes just over 60 seconds to compute the spatiotemporal diagram image of a single tube, so about 3 min for the 3 tubes. The calculations are finalized either by averaging the curves over several experiments (e.g., three tubes such as shown in FIG. 11) or by analyzing a spatiotemporal diagram image that averages over the diagram images of each experiment, and then computing the curve from that spatiotemporal diagram image (not shown). The complete data analysis is therefore about 5 minutes per experiment.

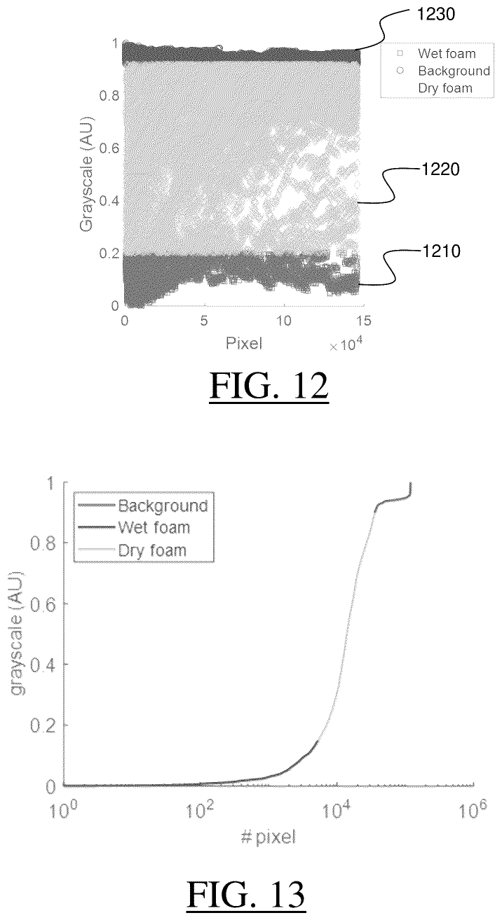

FIG. 12 shows an example of data that can be used to train a classification machine learning model. The experimental data may indeed be gathered to train a machine learning model. The data shows pixel counts versus grayscale intensity, showing regions of wet foam 1210, dry foam 1220 or background 1230. The regions may be classified manually, and then used for training the learning model. FIG. 13 shows the same data in a different representation, which may be used for training a logistic regression model.

The method may be applied to a large range of applications, ranging from enhanced oil recovery, degassing of crude oil, to solvents for CO2 capture, aeriation of lubricants in car engines, among others. Indeed, the method is not coupled to a particular acquisition system.

In addition, the method has the ability to treat systems with low contrast and more than two phases, e.g., with back and front illumination. The method has high transversality.

Alternative solutions for the segmentation are now discussed.

The above implementation uses a user-adjusted thresholding to perform the segmentation. This is because the tested implementation achieves a reasonable compromise between automation of the method, accuracy of the results and user intervention. Nonetheless, the method may use fully automated methods to perform the segmentation.

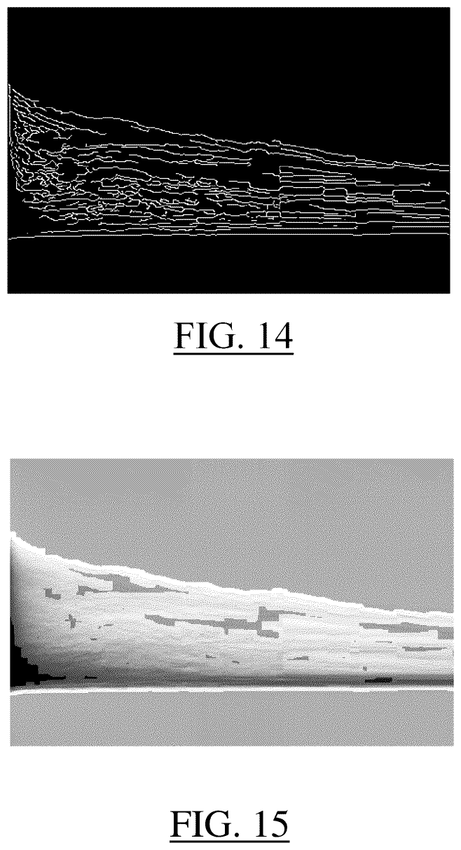

FIG. 14 for example shows an example where the spatiotemporal diagram image is passed through a Canny filter. The Canny filter detects boundaries. This allows to use texture analysis on the Canny filtered image (e.g., using local standard deviation or entropy) to find regions with more boundaries. This achieves a fully automatic segmentation.

FIG. 15 also shows that the image may be further segmented using local entropy on the Canny filtered image of FIG. 14, and prior to computing the curves.

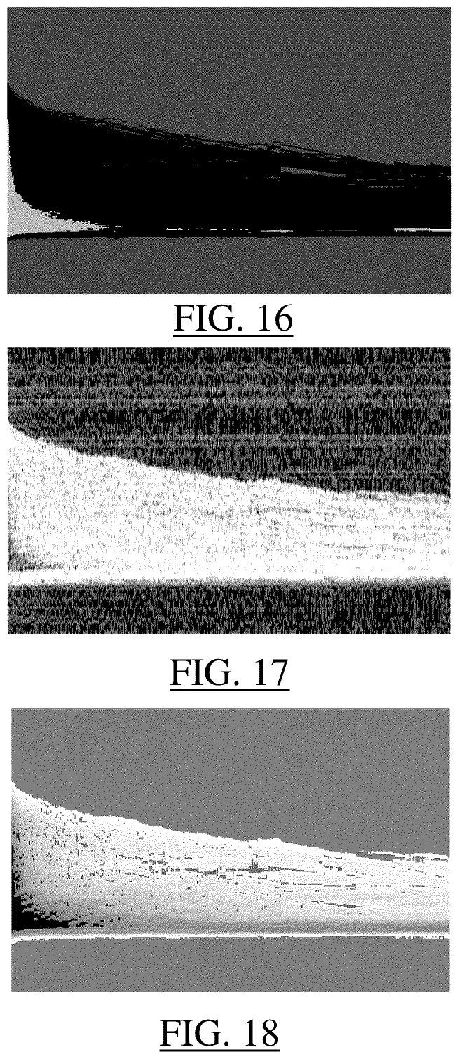

FIG. 16 shows another example where the segments are obtained via Otsu's method with ten thresholds.

FIG. 17 shows a segmentation using a local entropy filter with preference to horizontal patterns.

FIG. 18 shows a segmentation using local standard deviation analysis.

1. A computer-implemented method for analyzing the temporal evolution of a foam sample, the method comprising:
providing a time-series set of images of a foam sample subject to a shrinking process in a predetermined shrinking direction;
generating a spatiotemporal diagram image from the time-series set of images, the spatiotemporal diagram image representing time evolution of a layout of the foam sample in the predetermined shrinking direction;
segmenting the spatiotemporal diagram image into a set of segments; and
creating one or more curves that represent boundaries of the segments.

2. The method of claim 1, wherein the generating of the spatiotemporal diagram image comprises:
determining, from each respective image of the time-series set of images, a pixel stack representing the layout of the foam sample in the predetermined shrinking direction; and
juxtaposing laterally the pixel stacks.

3. The method of claim 2, wherein the determining of each respective pixel stack comprises, for each respective pixel of the pixel stack, averaging pixels of the respective image in a direction perpendicular to the predetermined shrinking direction.

4. The method of claim 1, wherein the segmenting is based on one or more graphical characteristics of the spatiotemporal diagram image including:
one or more pixel characteristics, such as intensity and/or grayscale level,
one or more local neighborhood characteristics, such as texture, entropy and/or standard deviation,
one or more pattern presence,
one or more connectivity criteria, and/or
one or more similarity criteria.

5. The method of claim 4, wherein the segmenting is based, for at least one respective graphical characteristic, on one or more thresholds of the respective graphical characteristic.

6. The method of claim 4, wherein the method comprises determining at least one respective threshold of a respective pixel characteristic by applying at least one of K-means clustering and Otsu's method.

7. The method of claim 4, wherein the segmenting comprises applying a predetermined learning model, for example to determine at least one respective threshold of a respective pixel characteristic.

8. The method of claim 7, wherein the determining of the at least one respective threshold comprises applying the learning model to the diagram.

9. The method of claim 7, wherein the predetermined learning model is a logistic regression model.

10. The method of claim 1, wherein the providing of the time-series set of images comprises:
positioning the foam sample in front of a camera sensor; and
capturing the time-series set of images with the camera sensor.

11. The method of claim 10, wherein the capturing is performed while lighting the foam sample.

12. The method of claim 1, wherein the method further comprises:
setting a region of interest on at least one of image; and
extracting, from each image, a respective sub-image corresponding to the region of interest;
the spatiotemporal diagram image being generated based on the sub-images.

13. The method of claim 1, wherein the foam sample is contained in a sampling tube having a bottom and an opening, the sampling tube being positioned vertically with the bottom downwards and the top upwards, the foam sample shrinking downwardly due to gravity.

14. The method of claim 1, further comprising displaying, on a graphical-user interface, the created one or more curves, optionally superposed on the generated spatiotemporal diagram image.

15. The method of claim 1, wherein the method further comprises computing a half-life and/or a drainage velocity of the foam sample from the one or more curves, and optionally displaying a graphical representation of the half-life and/or the drainage velocity.

16. The method of claim 15, wherein computing the half-life and/or drainage velocity from the one or more curves comprises determining a weighted sum of the one or more curves.

17. The method of claim 1, wherein the foam sample is one of:
a non-aqueous foam, comprising one or more of:
a depressurization-induced foam in a separator, the foam including hydrocarbons separating pockets of dissolved natural gases,
a gas treatment column foam and separating pockets of H2S, and/or CO2, or
a vehicle lubricant foam optionally in an electric vehicle gearbox, for example including mineral oil-based lubricant and separating pockets of air, or
a fuel foam optionally in a service station; or
an aqueous foam, comprising one or more of:
an enhanced oil recovery (EOR) foam, for example separating pockets of CO2, nitrogen, natural gas, and/or air, or
a gas treatment column foam including an amine-based solvent and separating pockets of CO2 and/or H2S.

18. (canceled)

19. A computer readable storage medium having recorded thereon a computer program comprising instructions for performing a computer-implemented method for analyzing the temporal evolution of a foam sample, the method comprising:
providing a time-series set of images of a foam sample subject to a shrinking process in a predetermined shrinking direction;
generating a spatiotemporal diagram image from the time-series set of images, the spatiotemporal diagram image representing time evolution of a layout of the foam sample in the predetermined shrinking direction;
segmenting the spatiotemporal diagram image into a set of segments; and
creating one or more curves that represent boundaries of the segments.

20. A system comprising a processor coupled to a memory, the memory having recorded thereon a computer program comprising instructions for performing a computer-implemented method for analyzing the temporal evolution of a foam sample, the method comprising:
providing a time-series set of images of a foam sample subject to a shrinking process in a predetermined shrinking direction;
generating a spatiotemporal diagram image from the time-series set of images, the spatiotemporal diagram image representing time evolution of a layout of the foam sample in the predetermined shrinking direction;
segmenting the spatiotemporal diagram image into a set of segments; and
creating one or more curves that represent boundaries of the segments.
